(19) United States
(12) Patent Application Publication
(10) Pub. No.: US 2006/0155595 A1
(43) Pub. Date: Jul. 13, 2006

(54) Method and apparatus of managing supply chain exceptions

(75) Inventor: Peter Johannsen, Valby (DK)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/035,136

(22) Filed: Jan. 13, 2005

(51) Int. Cl. G06Q 99/00; G06F 15/02; G06F 9/46

(52) U.S. Cl. 705/9; 705/1

(57) ABSTRACT

A method of managing supply chain exceptions includes identifying a root cause of an exception in the supply chain, creating at least one checkpoint related to the identified root cause of the exception, creating resolution alternatives to address the root cause of the exception, adding the checkpoint into an enterprise management system and adding the resolution alternatives to address the root cause of the exception into the enterprise management system.

### BACKGROUND

In today's competitive business environment, there has to be much greater interaction between the customers and manufacturers. This means that, in order to produce goods tailored to customer requirements and provide faster deliveries, the enterprise must be closely linked to both suppliers and customers. In order to achieve this improved delivery performance, decreased lead times within the enterprise and improved efficiency and effectiveness, manufacturers need to have efficient planning and control systems that enable very good synchronization and planning in all the processes of the organization. Today, however, the challenge is intense and requires a strong integration across the value chain. Enterprise Resource Planning is such a strategic tool, which equips the enterprise with the necessary capabilities to integrate and synchronize the isolated functions into streamlined business processes in order to gain a competitive edge in the turbulent business environment. However, exceptions in the supply chain can cause delays and inefficiencies, especially exceptions which are not promptly identified and addressed.

### SUMMARY

A method of managing supply chain exceptions is disclosed. The method may include identifying a root cause of an exception in the supply chain, creating at least one checkpoint related to the identified root cause of the exception, creating resolution alternatives to address the root cause of the exception, adding the checkpoint into an enterprise management system and adding the resolution alternatives to address the root cause of the exception into the enterprise management system. The method may also include communicating a notice of the initial discrepancy and predefined resolution alternatives, determining the time of the exception and determining ways of discovering the exception in the supply chain. The root cause of an exception may be an initial discrepancy that causes a delay in the supply chain. A checkpoint may be a determination whether an element of a supply chain meets a predetermined criteria. Exceptions may be discrepancies from a predetermined criteria such as incorrect quantities, time delays, lost or damaged goods and so on. A computer readable medium with computer instructions to execute the method and a computer system with a processor that is programmed to execute the method is also disclosed.

### DRAWINGS

FIG. 1 is a block diagram of a computing system that may operate in accordance with the claims; and

FIG. 2 is an illustration of a flowchart in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

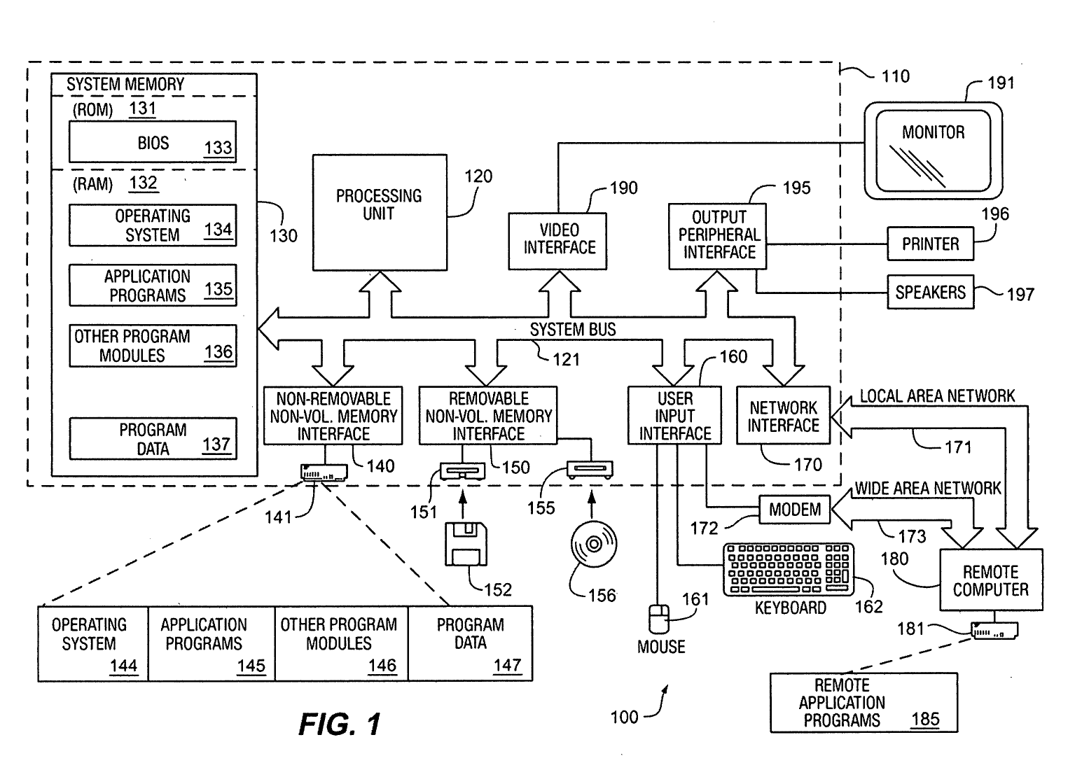

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system. 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

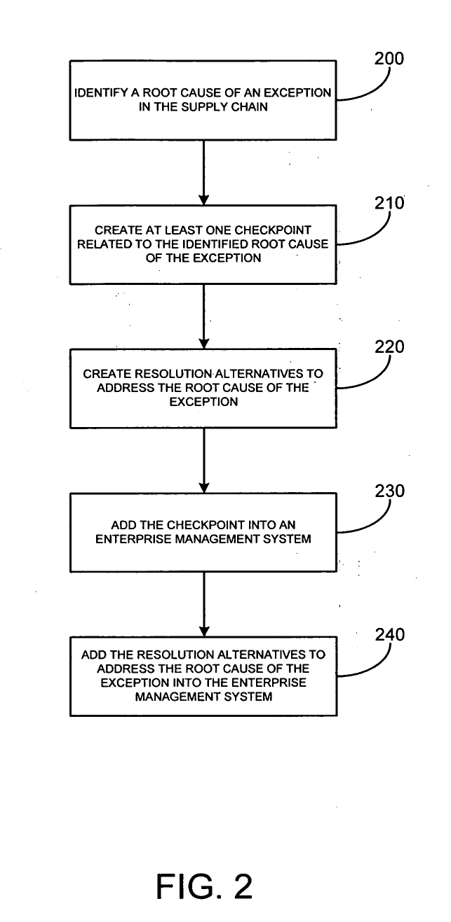

FIG. 2 is an illustration of a method of managing supply chain exceptions in accordance with the claims. At block 200, the method may identify a root cause of an exception in the supply chain. An exception in a supply chain may be a discrepancy in supply a good or service from a predefined criteria. For example, consider an automobile manufacturer that may need a predefined number of predefined wheels on a predefined day in order to maintain a given manufacturing schedule. A foundry may make the wheels and may be late in delivering some wheels or the number of wheels shipped may be incorrect or the wheels shipped may be the wrong wheels or the wheels may be lost or damaged in transit. Any of these exceptions from the predefined criteria may cause a delay in automobile production. Other exceptions may include intermediate products not delivered on time, incorrect quantity, incorrect product, incorrect time of delivery, damaged product, lost products (theft and gone missing),incorrect place of delivery and missing/wrong documents on delivery. The method may require that the root cause of the exception from the predetermined criteria be determined. For example, assuming the delivery of the wheels was late, the cause may have been that the proper aluminum needed to manufacture the wheels was late in being delivered to the foundry. As a result, the foundry may issue a notice that the wheels will be late in delivery.

The method may also determine ways of discovering the exception in the supply chain. For example, most foundries do not tell customers when the metal to be used in manufacture of its specific product has been delivered to the foundry. It may be simply assumed that the foundry will have the needed metal. However, a delay in receiving the proper metal certainly may cause a delay in the delivery of the needed wheels. Accordingly, by analyzing the root causes of a delay, new ways of discovering the exception may become apparent and related check points (was the proper metal delivered by date xx/yy/zzzz?) may be added to the system.

The method may be performed automatically by a computer program such as by an enterprise resource management program. The program may analyze the earliest exception and this may be determined to be the root cause. The program may also create a note for further analysis to be performed on the earliest exception to determine if there are other root causes.

At block 210, the method may create at least one checkpoint related to the identified root cause of the exception. A checkpoint may be a determination whether an element of a supply chain meets a predetermined criteria. In the automobile wheel example, a checkpoint may be put in place to determine whether the advance shipping notice indicated a ship date beyond the predetermined shipping date for the wheels. Additional checkpoints are possible. For example, a checkpoint may be added that indicates when the needed aluminum is delivered to the foundry or a checkpoint could be added that indicates the date the wheels are manufactured, the date the wheels are cleaned and prepared for shipping and the date that the wheels are actually shipped. A discrepancy of any of these checkpoints from a predetermined criteria (date, quantity, etc.) would be noted by the checkpoint.

At block 220, the method may create resolution alternatives to address the root cause of the exception. As there may be a variety of root causes, each root cause may have its own resolution alternatives. Resolution alternatives may be options that may be pursued such that the exception from the predetermined criteria can be corrected or worked around such that the delay in the supply chain will be minimized. For example, in the automotive wheel example, if the advanced shipping notice lists a date that is too late for the auto manufacturer, resolution alternatives may include calling the foundry to request earlier delivery, canceling the order and issuing a replacement order to another supplier, checking inventory to see if sufficient wheels are in inventory to prevent a manufacturing stoppage or substituting alternative wheels. Every root cause may have different resolution alternatives but the resolution alternatives may be the same for various root causes. For example, for many delays in the supply chain, a common resolution alternative may be to pursue supplies from another source.

At block 230, the method may add the checkpoint into an enterprise management system. Enterprise management systems, instead of treating each step in manufacturing as a separate transaction may attempt to consider the steps to be the part of the inter-linked processes that make up the business. By adding the checkpoint into an enterprise management system, the checkpoint may be automatically checked in order to keep all the inter-linked processes flowing as desires. In addition, the enterprise management system may permit “what-if” analysis of exceptions to the checkpoint. The enterprise resource management system may forward the checkpoint exception to a user or may use the checkpoint exception internally.

At block 240, the method may add the resolution alternatives to address the root cause of the exception into the enterprise management system. For example, in the automotive wheel example, if the advanced shipping notice lists a date that is too late for the auto manufacturer, resolution alternatives may include calling the foundry to request earlier delivery, canceling the order and issuing a replacement order to another supplier, checking inventory to see if sufficient wheels are in inventory to prevent a manufacturing stoppage or substituting alternative wheels. The resolution alternatives may also present the costs associated with each resolution alternative and the expected time to complete each of the resolution alternatives.

The method may also attempt to determine the time of the exception. By knowing the time of the exception, the method may be better able to evaluate the resolution alternatives. For example, if it takes two weeks to ship a wheel to the automobile manufacturer, an exception early in the manufacturing process may be overcome by changing to a faster delivery method. However, if the exception occurred shortly before the predetermined delivery time, ordering from a new supplier may not be an optimal solution.

By adding the checkpoints and resolution alternatives into the enterprise resource management system, potential delays can be identified earlier and a decision can be quickly made on choose a resolution alternative from a plurality of resolution alternatives. In addition, a delay early in a supply chain can trickle down the supply chain and cause additional disruptions to all the elements in the supply chain. For example, referring to the automobile wheel example, the wheels may need to have a chrome finish applied to the wheels before being delivered to the automobile manufacturer. If the wheels are late in leaving the foundry, the chrome supplier may no longer have time allotted to apply the chrome and the wheels may have to wait for the next available time at the chrome supplier, further delaying the delivery of the wheel to the automobile manufacturer.

In one embodiment, the resolution alternatives are displayed to a user and the user may be permitted to select the preferred resolution alternative but in another embodiment, the enterprise resource management system may be programmed to automatically evaluate the resolution alternatives and based on a criteria (such as lowest cost, least delay, etc.) and automatically proceed with at least one of the resolution alternatives. Yet another embodiment may evaluate a plurality of resolution alternatives and the resolution alternatives may be ranked in terms of optimization in view of a predetermined criteria which a user may choose to follow or can ignore. A variety of optimization schemes may be used such as lowest cost, fastest speed, most reliability, or a combination of a variety of optimization schemes with different weights placed on different schemes.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of managing supply chain exceptions comprising:
identifying a root cause of an exception in the supply chain;
creating at least one checkpoint related to the identified root cause of the exception;
creating resolution alternatives to address the root cause of the exception;
adding the checkpoint into an enterprise management system; and
adding the resolution alternatives to address the root cause of the exception into the enterprise management system.

2. The method of claim 1, wherein the root cause of an exception is an initial discrepancy that causes a delay in the supply chain.

3. The method of claim 2, further comprising communicating a notice of the initial discrepancy and predefined resolution alternatives.

4. The method of claim 1, wherein a checkpoint is a determination whether an element of a supply chain meets a predetermined criteria.

5. The method of claim 1, further comprising determining the time of the exception.

6. The method of claim 1, further comprising determining ways of discovering the exception in the supply chain.

7. The method of claim 1, wherein exceptions comprise discrepancies from a predetermined criteria.

8. A computer readable medium having computer executable instructions for performing a method of managing supply chain exceptions comprising:
computer executable instructions for identifying a root cause of an exception in the supply chain;
computer executable instructions for creating at least one checkpoint related to the identified root cause of the exception;
computer executable instructions for creating resolution alternatives to address the root cause of the exception;
computer executable instructions for adding the checkpoint into an enterprise management system; and
computer executable instructions for adding the resolution alternatives to address the root cause of the exception into the enterprise management system.

9. The computer readable medium of claim 8, wherein the root cause of an exception is an initial discrepancy that causes a delay in the supply chain.

10. The computer readable medium of claim 9, further comprising computer executable instructions for communicating a notice of the initial discrepancy and predefined resolution alternatives.

11. The computer readable medium of claim 8, wherein a checkpoint is a determination whether an element of a supply chain meets a predetermined criteria.

12. The computer readable medium of claim 8, further comprising computer executable instructions for determining the time of the exception.

13. The computer readable medium of claim 8, further comprising computer executable instructions for determining ways of discovering the exception in the supply chain.

14. The computer readable medium of claim 8, wherein exceptions comprise discrepancies from a predetermined criteria.

15. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to identify a root cause of an exception in the supply chain wherein the root cause of an exception is an initial discrepancy that causes a delay in the supply chain;
said processing apparatus being programmed to create at least one checkpoint related to the identified root cause of the exception;
said processing apparatus being programmed to create resolution alternatives to address the root cause of the exception;
said processing apparatus being programmed to add the checkpoint into an enterprise management system; and
said processing apparatus being programmed to add the resolution alternatives to address the root cause of the exception into the enterprise management system.

16. The computing apparatus of claim 15, further comprising said processing apparatus being programmed to communicate a notice of the initial discrepancy and predefined resolution alternatives.

17. The computing apparatus of claim 15, wherein a checkpoint is a determination whether an element of a supply chain meets a predetermined criteria.

18. The computing apparatus of claim 15, further comprising said processing apparatus being programmed to determine the time of the exception.

19. The computing apparatus of claim 15, further comprising said processing apparatus being programmed to determine ways of discovering the exception in the supply chain.

20. The computing apparatus of claim 15, wherein exceptions comprise discrepancies from a predetermined criteria.
